(19) United States
(12) Patent Application Publication
(10) Pub. No.: US 2015/0072106 A1
(43) Pub. Date: Mar. 12, 2015

(54) NANO-BOND JOINING FOR STRUCTURAL PANELS

(71) Applicant: GM Global Technology Operations LLC, Detroit, MI (US)

(72) Inventors: HESHAM A. EZZAT, TROY, MI (US); JOSEPH M. POLEWARCZYK, ROCHESTER HILLS, MI (US)

(73) Assignee: GM Global Technology Operations LLC, Detroit, MI (US)

(21) Appl. No.: 14/024,055

(22) Filed: Sep. 11, 2013

(51) Int. Cl. B32B 3/30; B32B 37/12; B32B 37/18; B23P 11/00

(52) U.S. Cl. CPC B32B 3/30; B23P 11/00; B32B 37/1284; B32B 37/18; B32B 2250/02
USPC 428/119; 29/505; 156/60; 156/308.2

(57) ABSTRACT

A number of variations may include a method may include providing a first part and a second part and forming a first plurality of prolongations on a surface of the first part and forming a second plurality of prolongations on a surface of the second part. The first part and the second part may be brought together and abutted such that the first plurality of prolongations abuts against the second plurality of prolongations. The first plurality of prolongations and the second plurality of prolongations may be constructed and arranged to mechanically bond. A load may be applied such that both the first plurality of prolongations and second plurality of prolongations temporarily deform and mechanically bond the first part and the second part together.

### TECHNICAL FIELD

The field to which the disclosure generally relates includes means of mechanically bonding parts together.

### BACKGROUND

Mechanically joining work pieces or parts together typically involve the use of localized heat application to facilitate the bonding of materials or joining work pieces together via an additional step or component such as an adhesive, nut-and-bolt combinations, soldering, welding, or a combination of similar methods.

### SUMMARY OF ILLUSTRATIVE VARIATIONS OF THE INVENTION

According to one variation, a method of joining two parts may include providing a first part that may include a first plurality of prolongations and providing a second part that may include a plurality of second prolongations and pressing the first part against the second part with an applied force such that the first plurality of prolongations mechanically bond with the second plurality of prolongations.

According to another variation, a product may include a first part that may include a first plurality of prolongations that may comprise at least one protuberant bulge and a second part that may include a plurality of second prolongations that may comprise at least one protuberant bulge and wherein the first plurality of prolongations and the second plurality of prolongations may both be constructed and arranged to simultaneously and cooperatively mechanically bond.

Other illustrative variations within the scope of the inventions will become apparent from the detailed description provided hereinafter. It should be understood that the detailed description and enumerated variations, while disclosing optional variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1A illustrates a sectional view according to one variation;

FIG. 1B illustrates a sectional view according to one variation; and

FIG. 1C illustrates a variation sectional view according to one variation.

### DETAILED DESCRIPTION OF ILLUSTRATIVE VARIATIONS OF THE INVENTION

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

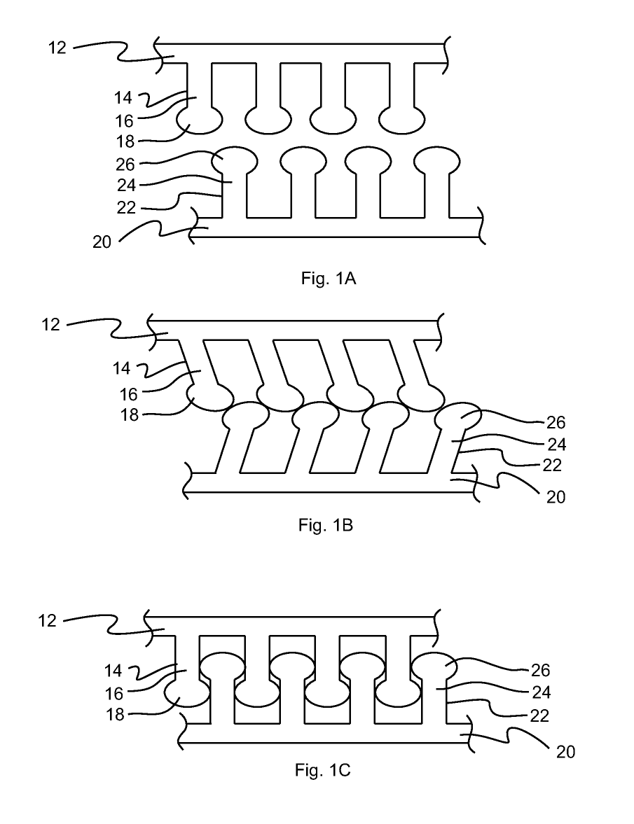

Referring to FIG. 1A; a first part 12 may include at least one first prolongation 14. The at least one first prolongation 14 may comprise a first stem 16 and a first bulge 18. The first bulge 18 may protuberate from the first stem 16. A second part 20 may include at least one second prolongation 22. The at least one second prolongation 22 may comprise a second stem 24 and a second bulge 26. The second bulge 26 may protuberate from the second stem 24.

Referring to FIG. 1B; the at least one first prolongation 14 may be constructed and arranged to temporarily deform under an applied load or force. Similarly, the at least one second prolongation 22 may be constructed and arranged to temporarily deform under an applied load or force. When under an applied load, prolongations 14 and 22 may both, or individually, temporarily deform when abutted against one another.

Referring to FIG. 1C; the at least one first prolongation 14 and the at least one second prolongation 22 may be constructed and arranged to simultaneously and cooperatively mechanically bond. In this way, the first part 12 and the second part 20 may be mechanically joined via the mechanical bonding of the at least one first prolongation 14 and the at least one second prolongation 22.

The first part may be a part for use in an automobile, aircraft, watercraft, or any vehicle or application where parts need to be joined at an interface. The first part may be formed from any material appropriate for the application.

The second part may be a part for use in an automobile, aircraft, watercraft, or any vehicle or application where parts need to be joined at an interface. The second part may be formed from any material appropriate for the application.

The at least one first or second prolongations may be formed on the surface of the first part, on the surface of the second part, or on the surface of both the first and second parts. The at least one first or second prolongations may be formed on the surface of a part via etching, micro-machining, chemical vapor deposition, or electrical deposition methods. Alternatively, the prolongations may be formed at the time the part itself is manufactured, for example, by a polymeric mold process. The at least one first or second prolongations may include a stem and a bulge. The at least one first or second prolongations may be microscopic, 100 micrometers or smaller in size, or nanoscopic, 100 nanometers or smaller, in size.

The first and second stems 16 and 24 may be generally cylindrical and elongated in shape and dimension and may extend perpendicularly from a surface of the first part 12 or from a surface of the second part 20 and may connect to a bulge 18 and 26.

The stems may alternatively be generally rib shaped and may extend parallel along a surface of a part adjacent to other ribs and may extend perpendicularly from a surface of the first part 12 or from a surface of the second part 20 and may connect to a bulge 18 and 26.

The bulges 18 and 26 may protuberate from the stems 16 and 24 and may be of a general disk or orb shape, though other three dimensional variations are considered to be within the scope of the inventions. In one variation, the bulges 18 and 26 may be generally orb or disc-like in shape. The bulges 18 and 26 bulge may include a first circular side connecting to a stem and a second circular side opposite the first circular side, the first side and second side may be joined by a curved portion having a circumference larger than that of the first circular side and the second circular side such that the bulge is generally disk-like in shape.

The bulges 18 and 26 may alternatively be generally cylindrically shaped and may extend along a top edge of a rib extending parallel and adjacent to other ribs such that the longitudinal axis of the cylindrical bulge runs parallel to the rib.

The first plurality of prolongations may be mechanically bonded to the second plurality of prolongations whereby a first surface of a first part that may include a first plurality of prolongations and may be abutted, under a load, against a second surface of a second part that may include a second plurality of prolongations. The first plurality of prolongations and second plurality of prolongations may temporarily or permanently deform and be caused to mechanically bond together such that each prolongation may be mechanically bonded, but not chemically bonded, to one or more nearby prolongations.

It is understood that although multiple examples have been provided, the prolongations, stems, and bulges may be of any size, shape, or dimensions as desirable for the application and the variations disclosed herein should not be construed to be all encompassing with respect to the scope of the inventions.

According to a first variation, a method may include providing a first part and a second part. The first part and the second part may include a first and second plurality of prolongations, respectively, that may be constructed and arranged to simultaneously and cooperatively mechanically bond. The method may also include abutting the first plurality of prolongations against the second plurality of prolongations and applying a load such that both the first plurality of prolongations and second plurality of prolongations may become mechanically bonded.

A second variation may include a method as set forth in the first variation wherein when applying a load, the first plurality of prolongations and second plurality of prolongations may temporarily deform prior to become mechanically bonded.

A third variation may include a method as set forth in the first or second variations further including applying an adhesive to the first surface, the second surface, or both prior to abutting the first plurality of prolongations against the second plurality of prolongations. The adhesive may then be cured.

A fourth variation may include a method as set forth in the first through third variations further including forming the first plurality of prolongations of a first surface of the first part and forming the second plurality of prolongations on a second surface of the second part prior to providing a first part and a second part.

A fifth variation may include a method as set forth in the fourth variation wherein forming the first plurality of prolongations on a first surface of the first part and forming the second plurality of prolongations on a second surface of the second part may be accomplished via etching.

A sixth variation may include a method as set forth in the fourth variation wherein forming the first plurality of prolongations on a first surface of the first part and forming the second plurality of prolongations on a second surface of the second part may be accomplished via chemical vapor deposition.

A seventh variation may include a method as set forth in the fourth variation wherein forming the first plurality of prolongations on a first surface of the first part and forming the second plurality of prolongations on a second surface of the second part may be accomplished via micro-machining.

An eighth variation may include a product as set forth in the first through seventh variations that may further include, after mechanically bonding the first plurality of prolongations and the second plurality of prolongations, heating the first part, the second part, or both such that the first part and second part bond together.

A ninth variation may include a product, the product may include a first part and a second part. The first part and the second part may each include a first and second plurality of prolongations, respectively, both constructed and arranged to simultaneously and cooperatively mechanically bond. The first plurality of prolongations and second plurality of prolongations may be mechanically bonded such that the first part and the second part make up the product.

A tenth variation may include a product as set forth in the ninth variation wherein each individual prolongation may include a stem and a bulge. The stem may be an elongated portion of an individual prolongation extending from a surface of the first or second part and may connect to a bulge.

An eleventh variation may include a product as set forth in the ninth and tenth variations wherein the bulge is generally orb-like in shape.

A twelfth variation may include a product as set forth in the ninth and eleventh variations wherein the bulge may have first circular side connecting to the stem and a second circular side opposite the first circular side. The first side and second side may be joined by a curved portion having a circumference larger than that of the first circular side and the second circular side such that the bulge is generally disk-like in shape.

A thirteenth variation may include a product as set forth in the ninth through twelfth variations that may further include an adhesive that may be located between the first part and the second part to further facilitate the mechanical bond between the first part and the second part.

A fourteenth variation may include a product as set forth in the ninth through thirteenth variations wherein each individual prolongation may include a stem and a bulge. The stem may be an elongated portion of an individual prolongation extending from a surface of the first or second part and may connect to a bulge. The stem may be generally rib shaped and elongated.

A fifteenth variation may include providing a first part and a second part; forming a first plurality of prolongations on a surface of the first part and forming a second plurality of prolongations on a surface of the second part. The first plurality of prolongations and the second plurality of prolongations may be constructed and arranged to mechanically bond. The first part and the second part may be brought together and abutted such that the first plurality of prolongations abuts against the second plurality of prolongations. A load may be applied such that both the first plurality of prolongations and second plurality of prolongations temporarily deform and mechanically bond the first part and the second part together. The applied load may be removed such that the first plurality of prolongations and second plurality of prolongations are no longer temporarily deformed.

A sixteenth variation may include a method as set forth in the fifteenth variation wherein each individual prolongation may include a stem and a bulge and the stem may be a generally rib shaped elongated portion of an individual prolongation extending from a surface of the first or second part and connecting to a bulge.

A seventeenth variation may include a method as set forth in the fifteenth variation each prolongation may include a stem and a bulge and the stem may be an elongated portion of an individual prolongation extending perpendicularly from a surface of the first or second part and connecting to the bulge.

An eighteenth variation may include a method as set forth in the fifteenth variation wherein forming the first plurality of prolongations on a surface of the first part may be accomplished via etching and forming a second plurality of prolongations on a surface of the second part may be accomplished via etching.

A nineteenth variation may include a method as set forth in the fifteenth variation wherein forming the first plurality of prolongations on a surface of the first part may be accomplished via chemical vapor deposition and forming a second plurality of prolongations on a surface of the second part may be accomplished via chemical vapor deposition.

A twentieth variation may include a method as set forth in the fifteenth variation wherein forming the first plurality of prolongations on a surface of the first part may be accomplished via micro-machining and forming a second plurality of prolongations on a surface of the second part may be accomplished via micro-machining.

The above description of variations of the invention is merely demonstrative in nature and, thus, variations thereof are not to be regarded as a departure from the spirit and scope of the inventions disclosed within this document.

What is claimed is:

1. A method comprising:
providing a first part and a second part wherein the first part comprises a first plurality of prolongations and the second part comprises a second plurality of prolongations and wherein the first plurality of prolongations and the second plurality of prolongations are constructed and arranged to mechanically bond;
abutting the first plurality of prolongations against the second plurality of prolongations;
applying a load such that both the first plurality of prolongations and second plurality of prolongations become mechanically bonded.

2. A method as set forth in claim 1 wherein when a load is applied the first plurality of prolongations and second plurality of prolongations temporarily deform prior to becoming mechanically bonded.

3. A method as set forth in claim 1 further comprising:
applying an adhesive between the first surface and the second surface prior to abutting the first plurality of prolongations against the second plurality of prolongations; and
curing the adhesive.

4. A method as set forth in claim 1 further comprising:
forming the first plurality of prolongations on a first surface of the first part and forming the second plurality of prolongations on a second surface of the second part prior providing a first part and a second part;
wherein each prolongation is microscopic or smaller in size.

5. A method as set forth in claim 4 wherein forming the first plurality of prolongations on a first surface of the first part and forming the second plurality of prolongations on a second surface of the second part comprises etching.

6. A method as set forth in claim 4, wherein forming the first plurality of prolongations on a first surface of the first part and forming the second plurality of prolongations on a second surface of the second part comprises chemical vapor deposition.

7. A method as set forth in claim 4 wherein forming the first plurality of prolongations on a first surface of the first part and forming the second plurality of prolongations on a second surface of the second part comprises micro-machining.

8. A method as set forth in claim 1 further comprising applying heat to the mechanically bonded first part and second part such that the first part and second part bond together.

9. A product comprising:
a first part and a second part, the first part comprising a first plurality of prolongations and the second part comprising a second plurality of prolongations, the first plurality of prolongations and second plurality of prolongations being constructed and arranged to mechanically bond; and
wherein the first plurality of prolongations and the second plurality of prolongations are mechanically bonded such that the first part and the second part form the product.

10. A product as set forth in claim 9 wherein:
each prolongation comprises a stem and a bulge; and
the stem being an elongated portion of an individual prolongation extending from a surface of the first or second part and connecting to the bulge.

11. A product as set forth in claim 9 wherein the bulge is generally orb-like in shape.

12. A product as set forth in claim 9 wherein the bulge comprises first circular side connecting to the stem and a second circular side opposite the first circular side, the first side and second side being joined by a curved portion having a circumference larger than that of the first circular side and the second circular side such that the bulge is generally disk-like in shape.

13. A product as set forth in claim 9 wherein an adhesive is located between the first part and the second part to further facilitate the mechanical bond between the first part and the second part.

14. A product as set forth in claim 9 wherein:
each individual prolongation comprises a stem and a bulge;
each prolongation is microscopic or smaller in size; and
the stem being a generally rib shaped elongated portion of an individual prolongation extending from a surface of the first or second part and connecting to a bulge.

15. A method comprising:
providing a first part and a second part;
forming a first plurality of prolongations on a surface of the first part;
forming a second plurality of prolongations on a surface of the second part;
wherein the first plurality of prolongations and the second plurality of prolongations are microscopic or smaller in size and wherein the first plurality of prolongations and the second plurality of prolongations are constructed and arranged to mechanically bond;
abutting the first plurality of prolongations against the second plurality of prolongations;
applying a load such that both the first plurality of prolongations and second plurality of prolongations temporarily deform; and
mechanically bonding the first part and the second part; and
removing the applied load such that the first plurality of prolongations and second plurality of prolongations are no longer temporarily deformed.

16. A method as set forth in claim 15 wherein
each individual prolongation comprises a stem and a bulge; and
the stem being a generally rib shaped elongated portion of an individual prolongation extending from a surface of the first or second part and connecting to a bulge.

17. A method as set forth in claim 15 wherein
each prolongation comprises a stem and a bulge;
each prolongation is microscopic or smaller in size; and
the stem being an elongated portion of an individual prolongation extending perpendicularly from a surface of the first or second part and connecting to the bulge.

18. A method as set forth in claim 15 wherein
forming the first plurality of prolongations on a surface of the first part is accomplished comprises etching; and
forming a second plurality of prolongations on a surface of the second part is accomplished comprises etching.

19. A method as set forth in claim 15 wherein
forming the first plurality of prolongations on a surface of the first part is accomplished comprises chemical vapor deposition; and
forming a second plurality of prolongations on a surface of the second part is accomplished comprises chemical vapor deposition.

20. A method as set forth in claim 15 wherein
forming the first plurality of prolongations on a surface of the first part is accomplished comprises micro-machining; and
forming a second plurality of prolongations on a surface of the second part is accomplished comprises micro-machining.
